(19) United States
(12) Patent Application Publication
(10) Pub. No.: US 2005/0023851 A1
(43) Pub. Date: Feb. 3, 2005

(54) Weed removal tool

(75) Inventors: Rodrigo Lopez, Evanston, WY (US); Isabel Lopez, Evanston, WY (US)

Correspondence Address: Squire, Sanders & Dempsey L.L.P.;Suite 2700, Two Renaissance Square, 40 North Central Avenue, Phoenix, AZ, 85004-4498, US

(73) Assignee: Ferrich Holdings, LLC

(21) Appl. No.: 10/629,664

(22) Filed: Jul. 28, 2003

(51) Int. Cl. A01B 1/16

(52) U.S. Cl. 294/50.6

(57) ABSTRACT

A weed removal tool for removing the entire weed, including the root is disclosed. The weed removal tool includes a handle connected to a shaft having a straight portion and an angled portion. A tool head is coupled to the angled portion such that the tool head can engage weeds in the ground when the tool is in use. The tool head includes one or more weed removing structures that engage and remove weeds.

### TECHNICAL FIELD OF THE INVENTION

This invention relates to gardening tools and, more specifically to an improved weed removal tool.

### BACKGROUND OF THE INVENTION

The removal of unwanted plant materials, such as weeds, from a garden is a time consuming and tedious task. One way to remove unwanted plant material is through the use of poisons. Poisons, however, are messy and cumbersome to apply. Also, other plants besides the intended target of the poison may be killed. Furthermore, it is impossible for many commercial and home gardeners to maintain an organic garden when they must resort to these poisons.

Therefore, to remove weeds without the use of harmful chemicals, gardeners must use various tools. String trimmers can be used to remove weeds but they only sever a weed at or above the root line leaving the root of the weed in the ground. If the root is not completely removed, the weed can grow back. Also string trimmers are difficult to use near other plants, are noisy and, in the case of gas powered string trimmers, produce a variety of air pollutants.

To eliminate the drawbacks of string trimmers, various hand held weed removal tools have been proposed. For example, U.S. Pat. No. 5,440,869 entitled “Weed Removal Rake” discloses a rake-like device that has a tool head-like portion that can be run through a large amount of weeds. However, this invention, with its razor sharp edges and tines, works by severing the weed at its stem, above the root. Other hand tools that operate by severing weeds at the stem and above the root include U.S. Pat. No. 1,666,374 and U.S. Pat. No. 1,089,542.

U.S. Pat. No. 2,010,303 discloses a garden hoe that can remove weeds. This garden hoe, however, has a plurality of twisted prongs that breaks up the soil and tills the soil when in use. This might be fine when preparing a new garden. However, it is unnecessarily damaging when trying to extract weeds in an existing garden. Also, while the specification of the patent indicates it can “uproot weeds”, the disclosed garden hoe includes a number of projecting points that could sever a weed.

U.S. Pat. No. 3,985,382 discloses a weed puller. This weed puller is designed to pull weeds out in their entirety, but is designed to work on only one weed or a clump of weeds in the same space at one time. Also, the user of this tool needs to stand almost directly over the weed, limiting the ability of the user to weed underneath other plants such as rose bushes or near a wall or other garden fixture.

Therefore, a need has arisen for an improved weeding tool.

### SUMMARY OF THE INVENTION

In one embodiment, a weed removal tool for removing the entire weed, including the root is disclosed. The weed removal tool includes a handle connected to a shaft having a straight portion and an angled portion. A tool head is coupled to the angled portion such that the tool head can engage weeds in the ground when the tool is in use. The tool head includes one or more weed removing structures that engage and remove weeds.

In one embodiment, the weed removal structures and the tines that separate the weed removal structures have no sharp edges. This reduces the likelihood of the weed being severed prior to removal. In one embodiment, the toll head includes beveled portions for assisting in digging into the soil.

In one embodiment, the weed removing structures are keyhole shaped openings that have a first small opening for compressing soil and a second, larger opening where the soil expands and the weed is engaged and removed.

The weed removal tool can also receive an extension to extend the range of the weed removal tool. The extensions are removable, increasing the versatility of the weed removal tool.

### BRIEF DESCRIPTION OF THE DRAWINGS

FIG. 1 is a side view of the weeding tool;

FIG. 2 is a top view of the weeding tool;

FIG. 3 is a top view of a right hand embodiment of the weeding tool;

FIGS. 4a and 4b are views of the head of the weeding tool;

FIG. 5 is a cutaway view of a handle for the weeding tool;

FIG. 6 is a view of the weeding tool including one embodiment of an optional extension handle;

FIG. 7 is a second embodiment of an optional extension handle for the weeding tool;

FIG. 8 is a double headed embodiment of the weeding tool; and

FIGS. 9a-9c are views of the weeding tool in use.

### DETAILED DESCRIPTION OF THE DRAWINGS

The present invention relates to an improved weeding tool that is able to pull a weed or other plant material in its entirety, including the root, from an unwanted area, such as in a flowerbed or by rose bushes. As used herein, a weed is any plant that is in an area when it is not wanted. The present invention includes a tool head that includes a plurality of openings that help to grab the weed without cutting it, thus removing all of a weed, including the root. By removing the root, the weed is permanently removed. In addition, the whole root is removed in such a way that disruption of the surrounding ground is minimized. This avoids disrupting the flowerbed or other area where the weed growth occurs, minimizing the time needed to fix the flowerbed after weeding.

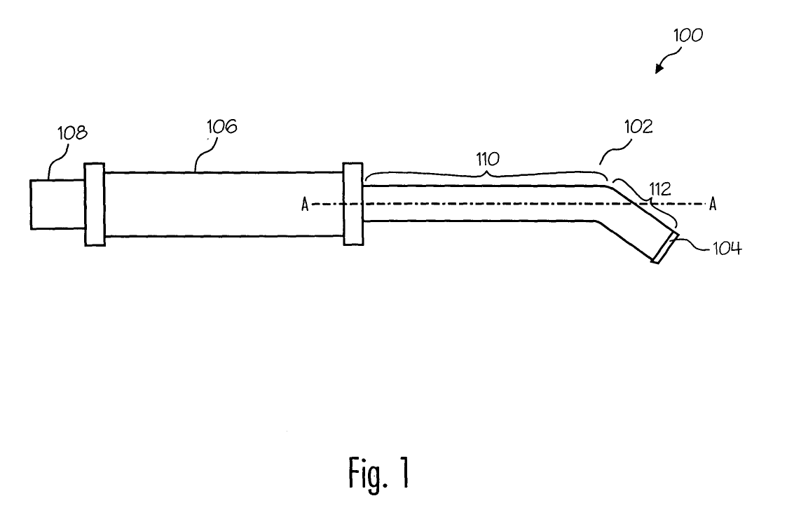

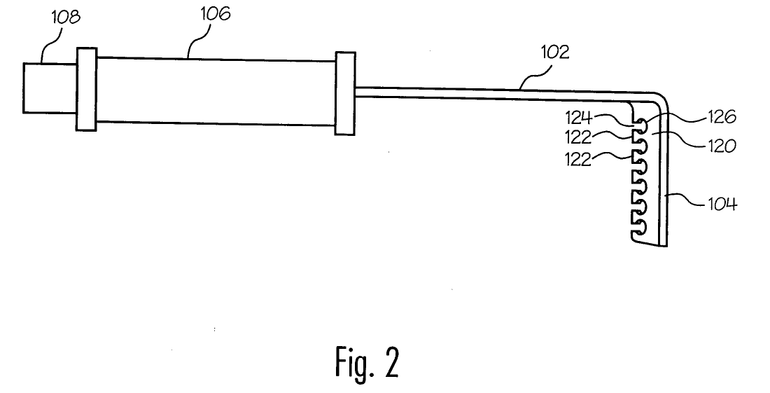

For example, weed tool 100 is designed to be a manually operated garden tool that completely removes weeds, including the root. Weed tool 100, referring to FIG. 1 and FIG. 2, includes a shaft portion 102 coupled to a tool head 104. Tool head 104 is more clearly seen in the top view of FIG. 2. Shaft portion 102 is coupled to handle 108. The user holds handle 108 when using weed tool 100. In one embodiment handle 108 includes a handle cushion 106.

Weed tool 100 is, in one embodiment, a hand tool designed to be used by an individual typically using one hand only on the tool, although embodiments of the weed tool 100 can require two hands. Tool 100 can be made of varying lengths. For example, in one embodiment, weed tool 100 can be made as a four-inch tool as measured from one end to the other end. This size would be a convenient pocket sized tool that can be easily carried by a gardener. A longer size for weed tool 100, such as eight inches in length would be a convenient length to remove weeds from around rose bushes or other thorny or sensitive plants without exposing the user to injury. The exact size to make the tool 100 depends on the application and needs of the user. Indeed, several sizes of tool 100 can be made and marketed.

Tool 100 can be made from any rigid and strong material. In one embodiment, tool 100 can be manufactured entirely from metal. Alternatively, the tool head 104 can be made from metal and the other parts made from wood, fiberglass or other materials. In one embodiment, the tool can be made from a hard plastic using an injection molding process or similar process. The exact materials used to make tool 100 are unimportant as long as the materials do not have sharp edges in the tool head 104. This allows for the removal of a weed in its entirety without severing the weeds.

Shaft portion 102 couples tool head 104 with tool handle 108. Shaft portion 102, as seen in FIG. 1, in one embodiment, has a relatively straight portion 110 and an angled portion 112. The angled portion 112 assists in the positioning of tool head 104 at the ground while the user's hand or hands remain above the ground. Thus, tool head 104 is able to dig into soil when a user holding on to the handle 108 manipulates the handle 108. In one embodiment, angled portion 112 is angled 10°-50° down from line A-A, the axis of the straight portion. The length of the straight portion 110 and the length of the angled portion 112 depend, on part, to the length of the tool 100 and is a routine design choice.

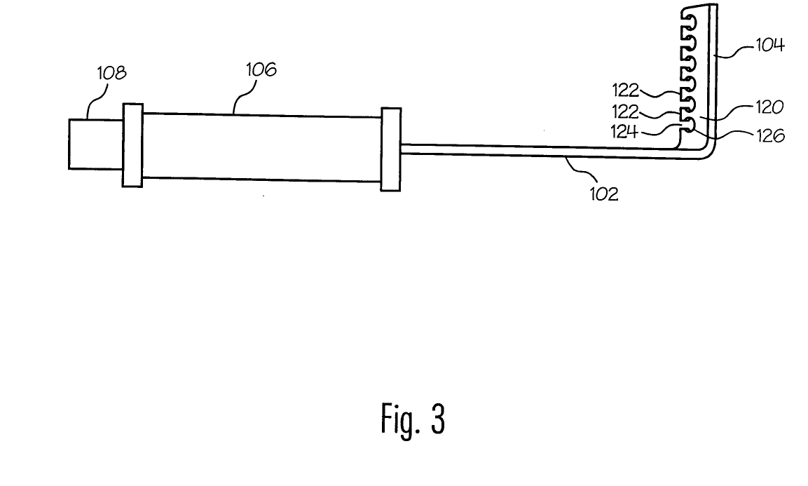

Tool head 104 digs into the soil and grabs the weed to remove the weed in its entirety, including the root. Tool head 104 connects to shaft portion 102. Tool head 104 extends outward from shaft portion 102. FIG. 1 and FIG. 2 illustrate a left-handed embodiment of weed tool 100. The embodiment is a left-handed weed tool 100 because, when held in a user's left hand, the tool head extends to the right. In a right-handed embodiment, the tool head 104 extends to the left when the handle 108 is held in a users right hand. A right-handed embodiment is illustrated as FIG. 3. Although both left handed and right handed weed tools can be produced, a single model, either the left handed tool or the right handed tool can be used by either a right handed or left handed individual.

In one embodiment, tool head 104 is offset at an angle with respect to the line A-A of the straight portion 110 of shaft portion 102. The offset of tool head 104 allows the tool head 104 to contact and dig into the soil such that the tool head 104 can contact weeds and other plant materials. In one embodiment tool head 104 is offset by an angle between 10-50 degrees with respect to line A-A.

As best seen in FIG. 2, tool head 104 includes one or more weed removing structures. The weed removing structures grasp the weed such that the entire weed is removed. In one embodiment, weed-removing openings comprise a plurality of keyhole openings 120 separated by a plurality of tines 122. Keyhole openings 120 have a small opening 124 between tines 122 with a large opening 126 coupled to the small opening 124. In one embodiment, small opening 124 is essentially rectilinear in shape while large opening 126 is essentially circular. While a rectilinear small opening 124 and an essentially circular large opening 126 are shown in FIG. 2, other shapes can be substituted. Indeed, weed-removing structures can be any structure that allows for the complete removal of a weed without severing the weed.

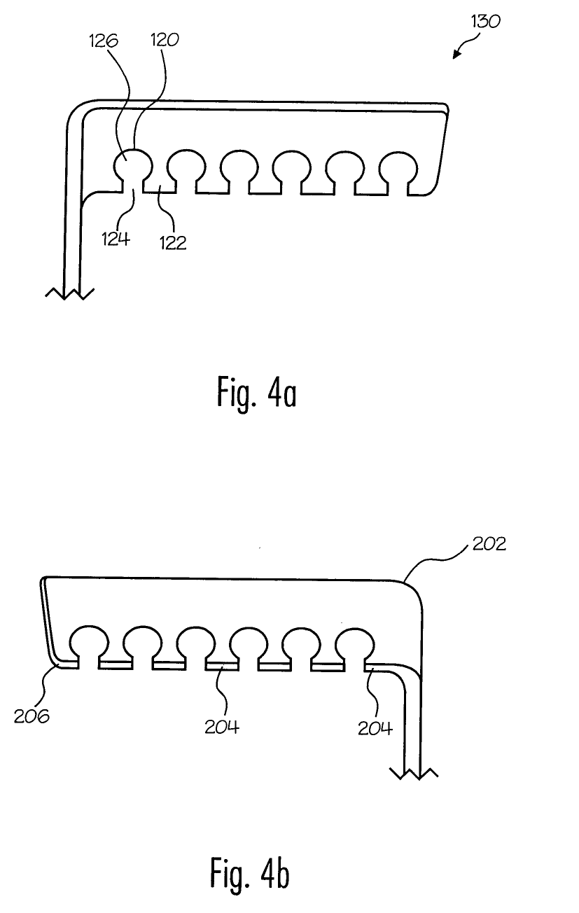

Referring to FIG. 2, tool head 104 includes a front side 130. Front side 130 is the side the user of tool 100 sees when the tool is in use. FIG. 4a illustrates the front side 130 of tool head 104 and FIG. 4b illustrates backside 202 of tool head 104. Visible on front side 130 of tool head 104 are a plurality of keyhole openings 120 separated by a plurality of tines 122. Keyhole openings 120 in one embodiment include a small opening 124, which is coupled to a large opening 126. In FIG. 4a five keyhole openings 120 are shown. However, other number of openings can be employed with the choice dependent on the length of tool head 104 and the spacing of the keyhole openings 120.

Backside 202 of tool head 104 shows the same keyhole openings 120 as front side 130. However, the tines 122 include a beveled portion 204. Beveled portion 204 allows tool head 104 to cut, dig, drag or otherwise enter into the soil to remove weeds. Beveled portions 204 are designed to allow the tool head 104 to enter the soil but not sharp enough to actually cut weeds because tool 100 is designed to remove a complete weed. Beveled portion 204 is beveled sufficiently to allow tool head 104 to dig into the soil. In one embodiment, the angle of the bevel is approximately 30° although other angles can be utilized. Additionally, backside 202 includes beveled side 206. Tool 100 can be rotated such that beveled side 206 contacts the soil. Beveled side 206 assists in the use of weed tool 100 by making it easier to dig into soil. Also, beveled side 206 can be used to dig into the soil in order to prepare the soil to plant seeds, or to break up hard soil.

Keyhole openings 120 and tines 122, preferably, do not have any sharp edges because the tool 100 is designed to remove the weed in its entirety. In operation, when the tool is moved across the soil, the keyhole openings 120 allow soil to first enter the small opening 124 where the soil is compressed. Next, the soil moves through the large opening 126 where the soil expands and loosens. This allows for the root of a plant to be grabbed at or near the base (where the stem and soil meet) and the plant is removed with the root.

The size of tool head 104 will vary depending on the size of the tool 100. For a tool of between eight and twelve inches, tool head 104 may be between two and five inches long, with a preferred size of two to three inches. The size of the keyhole openings will also vary depending on the size of the tool head 104. In one embodiment, the small opening may vary between 0.05 and 0.18 inches with, with a preferred range of 0.08 to 0.11. The second large opening may be range from a 0.1 to 0.2 diameter circle, with a preferred size of 0.11 to 0.13. In one embodiment, for a twelve-inch long tool 100, tool head is two inches long, with each small opening 0.9 inches wide and each large opening 0.125 inches in diameter.

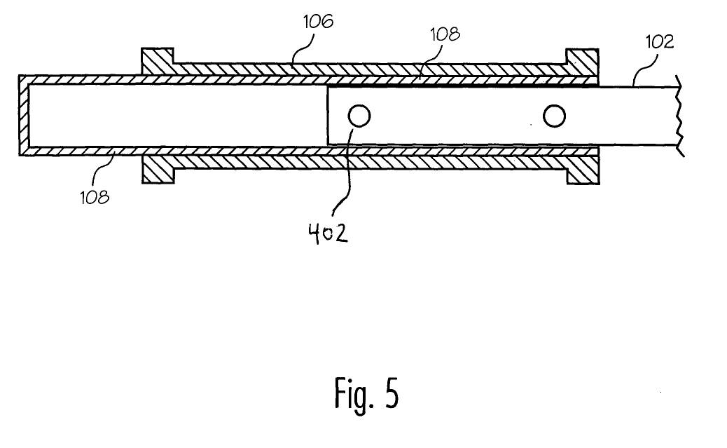

One embodiment of the connection of shaft 102 to the handle 108 is shown in FIG. 5. In this embodiment, the straight portion 110 of the shaft portion 102 is connected to handle 108 using rivets 402. Other means of connecting the straight portion 110 of the shaft portion 102 to handle 108 can be used including but not limited to welding the straight portion 110 of the shaft portion 102 to handle 108 or any other means to connect handle 108 to the straight portion 110 of the shaft portion 102. The choice of how to connect the straight portion 110 of the shaft portion 102 to handle 108 depends in part on materials used for shaft portion 102 and handle 108. For example, welding may be appropriate if handle 108 and shaft portion 102 were both made from metal. If handle 108 is made of wood and shaft portion 102 is made from metal, the straight portion 110 of the shaft portion 102 may be secured by bolts, screws or other means known to those in the art. Additionally, the handle 108 and shaft 102 may be made as a single piece, such as a single piece of metal or plastic.

Tool 100 also includes a handle cushion 106. Handle cushion 106 is used to make the tool 100 more comfortable to use as well as provide a secure grip for the user. Handle cushion 106 can be made from any material that both cushions the user's hand and provides a secure grip. Examples include foam, plastic, rubber and the like. Handle cushion 106 maybe a one-part cushion or may comprise multiple parts.

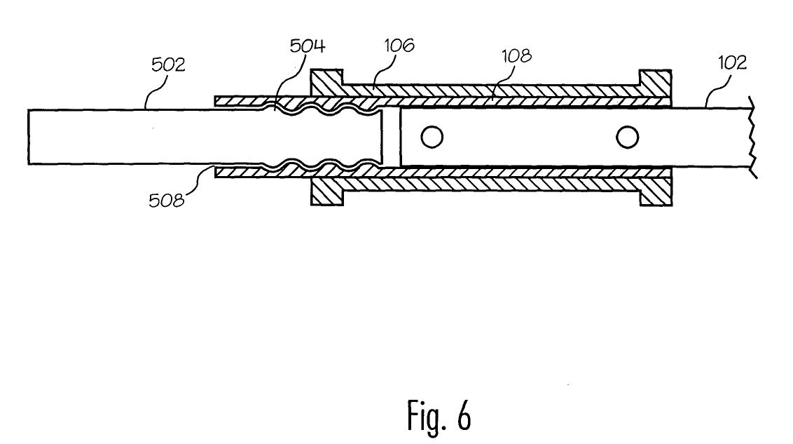

While tool 100 can be used as a single-handed hand tool, in an alternative embodiment tool 100 can receive an extension that couples to tool 100 to increase the reach of tool 100. FIG. 6 is a partial cutaway view of tool 100 illustrating an embodiment of an extension where the extension 502 includes screw threads 504. In this embodiment screw threads 504 can be screwed into tool 100. Tool 100 includes an opening 508 that receives screw threads 504 of the extension 502 into the tool 100. Extension 502 can allow a user to stand and weed an area. It can also allow the user to reach distant weeds.

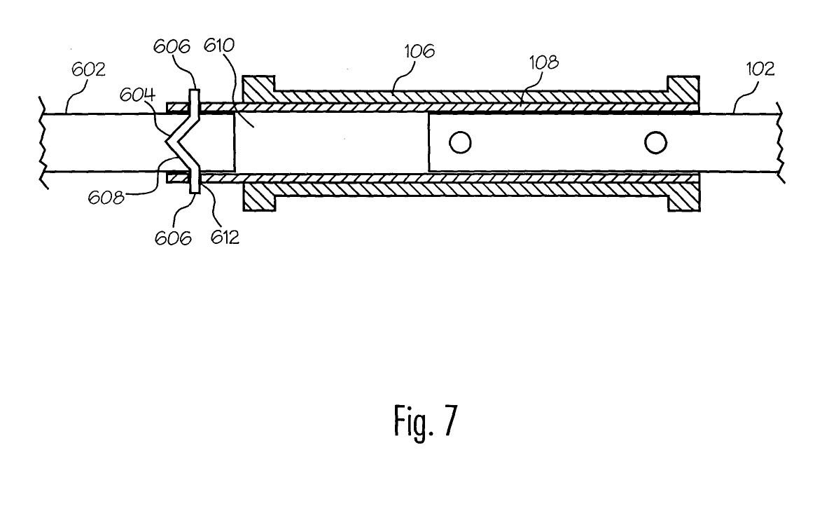

FIG. 7 is a second embodiment of connecting an extension to tool 100. In this embodiment extension 602 includes a flexible clip 604 that includes a post 606 on either side. These posts extend through openings 608 in extension 602. By compressing flexible clip 604, extension 602 can be inserted into opening 610 of tool 100. When the extension 602 aligns with openings 612 of tool 100, flexible clip 604 extends and posts 606 will extend through openings 608 in extension 602 and openings 612 of tool 100. Thus securing extension 602 to tool 100. In this manner, tool 100 can now be used to weed at a further distance.

FIG. 6 and FIG. 7 illustrate two embodiments to extend the length of tool 100. Any other manner to add an extension to a gardening tool can be used. For example, tool 100 can be designed to have a telescoping handle 108 or shaft 102. Alternatively, shaft 102 can be mounted on to a long handle. The extensions, such as those illustrated in FIG. 6 and FIG. 7 are removable, allowing the conversion to and from a single-handed tool to a longer garden tool.

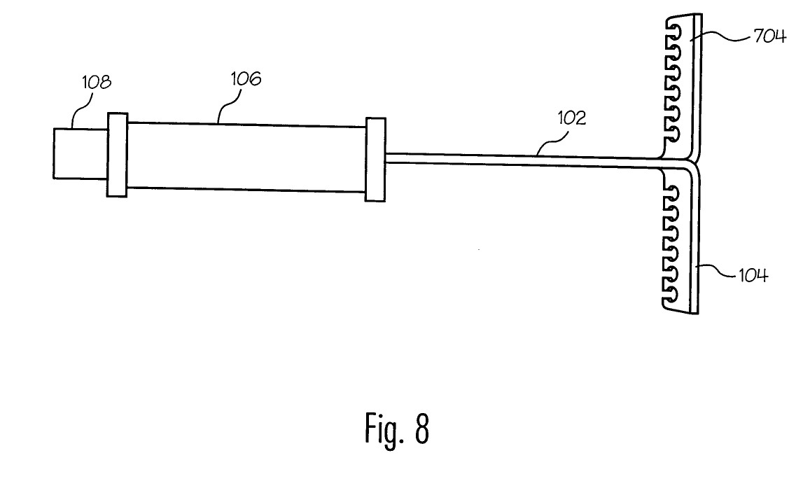

FIG. 8 is an embodiment of weed tool 100 that includes a second tool head 704. In this embodiment the addition of the second tool head 704 allows for the user to remove weeds from a greater area than a tool with one tool head. In the embodiment of FIG. 7, the size of each tool head may be enlarged as compared to the size of the one-headed embodiment. Also, the number of openings may be increased in order to remove more weeds in a given area.

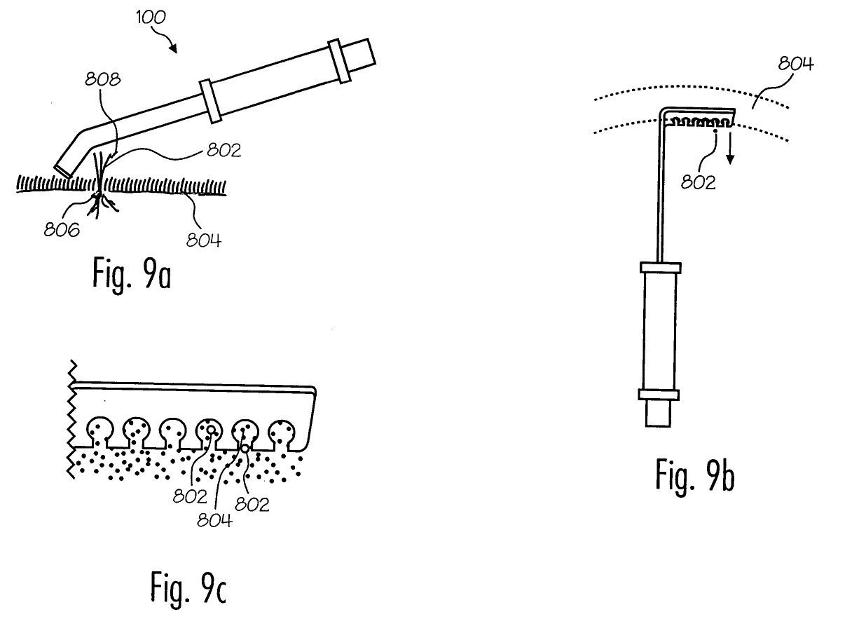

As seen in FIGS. 9a, 9b and 9c, tool 100 is used to remove weed 802 from the soil 804. Weed 802, as seen in FIG. 9a, includes a root section 806, below the ground and a surface portion 808, above the ground. In one embodiment, in order to remove weed 802, tool 100 is placed behind weed 802 and tool 100 is then manipulated to allow, in one embodiment, the tool head 104 of tool 100 to enter into the soil 804. This is typically done by moving the tool forward and allowing the beveled, angled tool head 104 to enter the soil. The tool is moved forward as shown in the above view of FIG. 9b. The small openings 124 and large openings 126 allow soil to pass through them until the root portion 806 of weed 802 or the base of the weed between the root 806 and the surface 808 of the plant is engaged by large opening 126 as seen in FIG. 9c. In FIG. 9c the tool head 104 is below the soil. Weed 802 is within a large opening of the keyhole opening 120. As the tool is pulled towards the user, the weed, due in part to the secure hold that is produced by the combination of the soil in the keyhole opening 120 and the shape of the opening, is pulled out of the ground in its entirety. Thus, tool 100 can be used to completely remove weeds with the roots and allows the user to work near other plants such as rose bushes while removing weeds. The lack of sharp edges on tool head 104 helps to prevent the severing of the weed prior to removal. The tool 100 can also remove weeds without digging into the ground by grasping a portion of a weed between the top and the root that is above the ground.

Having now described preferred embodiments of the invention, modifications and variations that do not depart from the spirit of the invention may be conceived by others. The invention is thus not limited to the preferred embodiments, but is instead set forth in the following claims and legal equivalents thereof.

1. A weeding tool for the removal of weeds in their entirety comprising:
a shaft portion having a first and a second end;
a tool head portion coupled to the second end, the tool head portion comprising one or more weed removing structures having no sharp edges.

2. The tool of claim 1, wherein the shaft portion further comprises a straight portion and an angled portion, the straight portion located at the first end, the angled portion connected to the tool head.

3. The tool of claim 1, wherein the one or more weed removing structures comprises one or more keyhole openings.

4. The tool of claim 1 wherein the tool head portion is offset at an angle with respect to the straight portion of the shaft portion.

5. The tool of claim 1 wherein the shaft portion is mounted to a handle to form a hand tool.

6. The tool of claim 5 where an extension is attached on the handle.

7. The tool of claim 6 wherein the extension is screwed into an opening on the handle.

8. The tool of claim 6 wherein the extension is mounted in the handle using an expansion clip.

9. The tool of claim 4 wherein each of the one or more keyhole openings comprises a first small opening and a second large opening, the first small opening operable to compress soil when the tool is used, the second opening allowing the soil to loosen, trapping the stem of a weed with the soil and allowing for the entire removal of the weed.

10. The tool of claim 9 wherein the small opening is generally rectilinear shaped and the large opening is generally circular.

11. The tool of claim 3 wherein the one or more keyhole openings are separated by tines, the tines having beveled edges to assist the tool head in digging into the ground.

12. The tool of claim 1 where in the tool head further comprises a beveled side for digging into soil.

13. The tool of claim 1 comprising a second tool head mounted on to the shaft.

14. The tool of claim 5 wherein the handle further comprises a cushioned portion.

15. A weeding tool comprising: a handle;
a shaft having a first end connected to the handle; and
a tool head coupled to a second end of the shaft, the tool head comprising one or more weed removing structures, operable to engage a weed and remove the weed without severing the weed.

16. The tool of claim 15, wherein the shaft portion further comprises a straight portion and an angled portion, the straight portion located at the first end, the angled portion connected to the tool head.

17. The tool of claim 15, wherein the one or more weed removing structures comprises one or more keyhole openings.

18. The tool of claim 15 wherein the tool head portion is offset at an angle with respect to the straight portion of the shaft portion.

19. The tool of claim 15 wherein the shaft portion is mounted to a handle to form a hand tool.

20. The tool of claim 18 wherein each of the one or more keyhole openings comprises a first small opening and a second large opening, the first small opening operable to compress soil when the tool is used, the second opening allowing the soil to loosen, trapping the stem of a weed with the soil and allowing for the entire removal of the weed.

21. A tool head for a weeding tool comprising one or more weed removing structures, each of the one or more weed removing structures separated by a tine, each of the one or more weed removing structures and the tines free from sharp edges.

22. The tool head of claim 21, wherein the one or more weed removing structures comprise one or more keyhole openings.

23. The tool head of claim 22 wherein each of the one or more keyhole openings comprises a first small opening and a second large opening, the first small opening operable to compress soil when the tool is used, the second opening allowing the soil to loosen, trapping the stem of a weed with the soil and allowing for the entire removal of the weed.

24. The tool head of claim 23 wherein the small opening is generally rectilinear shaped and the large opening is generally circular.

25. The tool head of claim 21, wherein the tool head is mounted on to a shaft having a handle.
